(19) United States
(12) Patent Application Publication
(10) Pub. No.: US 2004/0047568 A1
(43) Pub. Date: Mar. 11, 2004

(54) Testing of optical coupling devices

(75) Inventors: Donald Leroy Lester, Ballston Lake, NY (US); James Wilson Rose, Guilderland, NY (US)

Correspondence Address: Paul J. Esatto, Jr., Scully, Scott, Murphy & Presser, 400 Garden City Plaza, Garden City, NY, 11530, US

(73) Assignee: Lockheed Martin Corporation, Bethesda, MD (US)

(21) Appl. No.: 10/236,218

(22) Filed: Sep. 6, 2002

(51) Int. Cl. G02B 6/42

(52) U.S. Cl. 385/88

(57) ABSTRACT

A system and method for the direct inspection of an optical module. The system includes an optical receiver and/or an optical transmitter, an alignment means precisely dimensioned to interface with a predetermined optical coupling device, and electrical connection means operative to energize an optical coupling device or to receive an electrical output from an optical coupling device. These components may be integrated into a testing probe head. To inspect, the optical module is optically interfaced using precisely dimensioned alignment means, electrically interfacing the optical coupling device to energize the optical coupling device and/or to receive an electrical output from said predetermined optical coupling device. Further, the optical module is either electrically energized and the optical output measures, or optically energized and the electrical output measured. The measured optical or electrical output is compared to the expected output based on the electrical or optical energy applied.

### BACKGROUND OF THE INVENTION

1. Field of Invention

The invention relates generally to the field of electronics manufacturing and, more specifically, to a method and apparatus for the optical testing of an optical coupling module.

2. Description of Related Art

In an optical coupling device, such as an optical module, the coupling quality is directly related to the precise positioning of the optical element. To inspect the optical coupling quality of optical module, precising or alignment holes are utilized. Typically, conventional physical (x,y) position measurements are made of the alignment holes. Using this data, and the presumed relative position of the optical element in the optical module, the optical coupling quality of the optical module can be estimated to a certain level of accuracy.

This method has certain drawbacks. Primarily among them, the mechanical position of the alignment holes is only a rough approximation of the optical coupling quality of the optical module. Mechanical alignments such as surface flatness, drill perpendicularity, camber, die tilt and the interactions are not considered when measuring the x,y position of the hole nor can they be derived. Measurement of these other mechanical alignments and their combined effect on the overall optical coupling quality is laborious and remains an approximation. Because of this approximation, some unacceptable products may be passed while some suitable products may be rejected. Therefore, a reliable, accurate, direct measurement of optical coupling quality is desired.

### BRIEF SUMMARY OF THE INVENTION

To overcome these and other deficiencies in the prior art the present invention describes a system and method for the direct inspection of an optical module. The system comprises either or both of an optical receiver and an optical transmitter, an alignment means precisely dimensioned to interface with a predetermined optical coupling device, and electrical connection means operative to energize an optical coupling device or to receive an electrical output from an optical coupling device. These components may be integrated into a testing probe head.

The method according to the present invention comprises using precisely dimensioned alignment means to optically interface with a predetermined optical coupling device, electrically interfacing said optical coupling device to either energize said predetermined optical coupling device or to receive an electrical output from said predetermined optical coupling device. The method further comprises either electrically energizing the optical coupling device and measuring an optical output therefrom, or optically energizing the optical coupling device and measuring an electrical output therefrom, and comparing the optical or electrical output from said optical coupling device to the optical or electrical output expected based on the electrical or optical energy applied.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 illustrates a side elevation view of a test probe system according to the current invention in position to test an optical coupling device; and

FIG. 2 illustrates a plan view of an optical coupling device to be inspected according to the present invention.

### DETAILED DESCRIPTION OF THE INVENTION

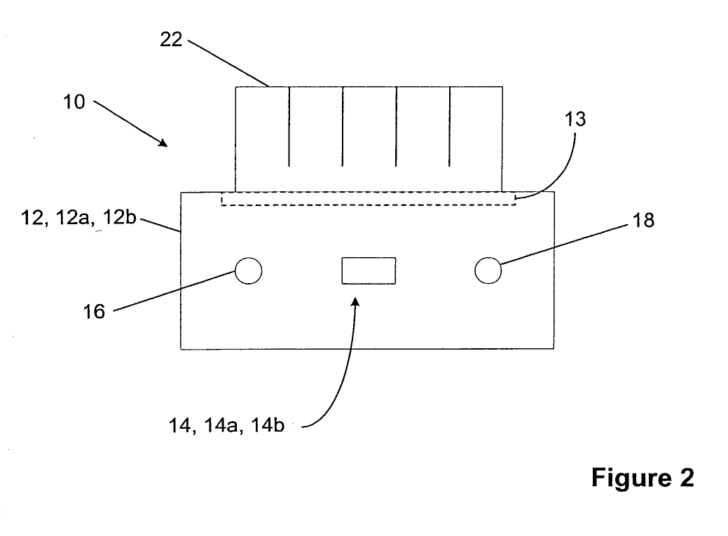

Referring now to FIG. 2, an optical coupling device to be inspected, generally 10, is illustrated. The optical module 12 may be positioned on a flex frame surface 20 after fabrication. The flex frame surface may be provided with electrical interface fingers 22, although any suitable means for electrically interfacing with an electrical contact portion 13, such as a plurality of wire bonding pads, of optical module 12 is acceptable.

The optical module 12 may be provided with one or more alignment holes 16, 18. These alignment holes 16, 18 are formed at a predetermined position of optical module 12. Shown in FIG. 2 as through holes, alignment holes 16, 18 may pass only partially through optical module 12. Alignment holes 16, 18 may also be positioned elsewhere on optical module 12, for example out to the perimeter. The alignment holes 16, 18 may be any suitable shape, such as the circular shape illustrated in FIG. 2.

The optical module 12 has an optical element 14 located at a predetermined position of optical module 12. Optical element 14 may be either a transmitting element 14a, for example a laser diode array, defining a transmitting optical module 12a. Optical element 14 may also be a receiving element 14b, for example a photodiode, defining a receiving optical module 12b.

The use of the optical coupling device 10 will be described. In the case of a transmitting device, the transmitting optical module 12a is charged via the electrical contact portion 13, and light is emitted from transmitting element 14a. The intensity of light emitted from transmitting element 14a may be fixed, or may vary according to the nature of the charge applied to the electrical contact portion 13. For example, the intensity may be proportionally, exponentially, or in some other way related, to either the voltage or current applied. The intensity may also be dictated by a digitally or otherwise coded electrical input to the transmitting optical module 12a.

In the case of a receiving device, light is incident upon the receiving element 14b, after which the receiving optical module 12b would generally produce an output via the electrical contact portion 13. The receiving optical module 12b may be designed such that the light intensity can vary the nature of the charge output through the electrical contact portion 13. The relationship between the light intensity received and the electrical output may be fixed, may vary proportionally, exponentially or according to some other relationship, or may be digitally or otherwise electrically encoded.

In the case of either the transmitting or receiving device, the optical module 12 may be designed to operate only in a predetermined portion of the electromagnetic (EM) spectrum, such as IR or UV. It may also have some inherent or designed threshold before the optical element 14 becomes active relative to the electrical contact portion 13.

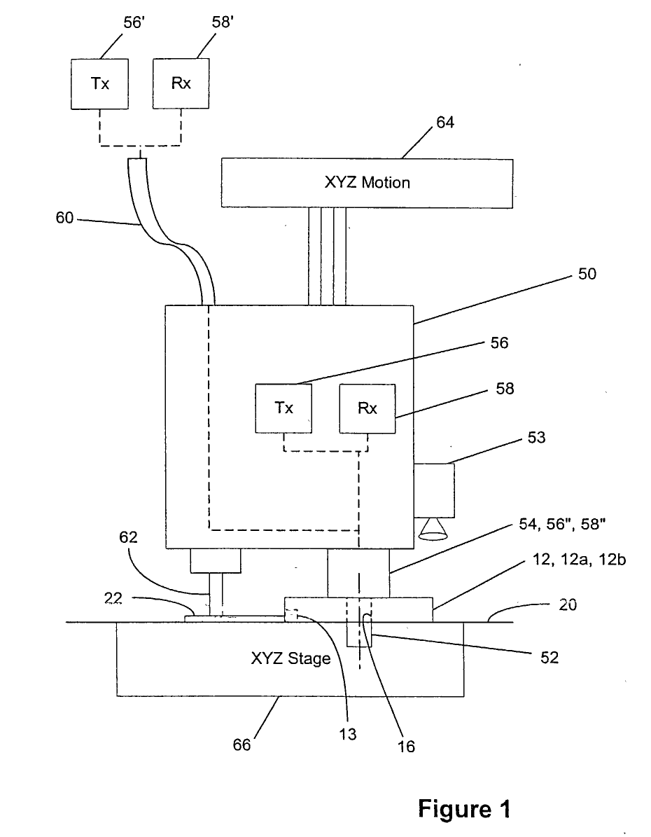

Referring now to FIG. 1, the system and method for inspecting the optical coupling device 10 will now be described. Optical module 12 is shown positioned on a flex frame surface 20. Probe head 50 is shown positioned above optical module 12 in a position to take a measurement of optical coupling quality.

Probe head 50 has one or more alignment means 52, such as alignment pins, the number, size and position of which are predetermined to physically interface with a selected optical module 12. Alignment means may also be pins or other structural elements, such as an inverse mold, dimensioned to physically interface with the exterior of a predetermined optical module 12, for example where optical module 12 is not provided with alignment holes 16, 18. Alignment means 52 may also comprise a machine vision system 53, either solely or as a supplement to one of the physical embodiments already described. The probe head 50 may also have an optical conduit means 54, such as a fiber optic connector, for optically interfacing the probe head 50 with the optical module 12 being tested. The probe head may also be provided with either or both of an optical receiver 56 and an optical transmitter 58.

In one embodiment, optical receiver 56 and optical transmitter 58 are provided integral to probe head 50; which is to say these are physically connected so as to move together as a single unit. In an alternate embodiment, however, an optical receiver 56′ and/or optical transmitter 58′ are provided remotely to the probe head 50, and communicate with optical conduit 54 via an interface cable 60. In yet another alternate embodiment optical coupling means 54 is omitted, and an optical receiver 56″ and/or optical transmitter 58″ is positioned to optically interface the optical module 12 directly. The probe head 50 may also be provided with more than one transmitter or receiver, for example ones operative in an IR or UV band of the EM spectrum.

Probe head 50 may also be provided with electrical connection means 62 for electrically interfacing optical module 12. Electrical connection means 62 may be a probe for interfacing via electrical interface fingers 22, a connector or harness, or any other suitable connection means. However, electrical connection means 62 need not be provided integral to the probe head. In an alternate embodiment, electrical connection means 62 may be a separate component, and/or integrated into a means for holding optical module 12 in position for testing, which might include a movable stage 66.

In any of the above cases, the alignment means 52, and either optical conduit means 54 or one of an optical receiver 56″ and an optical transmitter 58″, are precisely positioned to superior dimensional accuracy corresponding to the optical module 12 being tested. Therefore, any deficiency in optical coupling quality can be accurately presumed to result from dimensional errors of the optical module 12.

The testing method according to the present invention will now be described. Probe head 50 is positioned as shown in FIG. 1 by aligning the alignment means 52 with alignment holes 16, 18 of optical module 12. By virtue of the dimensional accuracy of the probe head, the optical element 14 should be in position to optically interface with the optical conduit means 54. At the same time, electrical connection means 62 is interfaced with the electrical contact portion 13 of optical module 12, for example through electrical interface fingers 22.

In the case of testing a transmitting optical module 12a, once in position, the transmitting optical module 12a is energized by the electrical connection means 62 to produce a given optical output at transmitting element 14a. The optical output is collected, for example via optical coupling means 54, and directed to optical receiver 56. In this context, “collected” will be understood to include channeling, as for measurement, not solely capacitive capture and storage of the optical energy. The quantity of light collected by optical receiver 56 is compared to the given optical output. This ratio is the measure of optical coupling quality of transmitting optical module 12a.

Because of the superior dimensional accuracy of the probe head 50, any misalignment between transmitting element 14a and optical coupling means 54 can be attributed to defects in the location of the transmitting element 14a. Moreover, regardless of the true position of transmitting element 14a, the critical measure of the functionality of transmitting optical module 12a is the amount of light delivered to the expected location above the transmitting optical module 12a, which is directly measured by the present invention.

In the case of testing a receiving optical module 12b, once the probe head 50 and electrical connection means 62 are in position, optical transmitter 58 is energized to supply a known quantity of light energy to an expected position above receiving optical module 12b. The electrical output from the receiving optical module 12b is collected via electrical connection means 62. In this context, “collected” will be understood to include channeling, as for measurement, not solely capacitive capture and storage of the electrical energy. The collected electrical output of receiving optical module 12b is compared to the expected electrical output, given the known quantity of light applied to the receiving element 14b. This ratio is the measure of optical coupling quality of the receiving optical module 12b. Again, regardless of the true position of receiving element 14b, the critical measure of the functionality of receiving optical module 12b is the electrical output derived from a given amount of light delivered to the expected location above the receiving optical module 12b, which is directly measured by the present invention.

To position probe head 50 above optical module 12 for testing, the probe head 50 may be attached to a motion control device 64, preferably one having at least three axes of motion. Alternately, the probe head 50 may be fixed and the optical module may be mounted on a movable stage 66, again preferably having at least three axes of motion. Alternately, the motion control device 64 and a movable stage 66 may be combined to achieve up to three or more axes of relative motion between probe head 50 and optical module 12. When either or both of motion control device 64 and movable stage 66 are used in automated testing, it is particularly useful for the alignment means 52 to include a machine vision system 53, irrespective of any other physical alignment components, to aid in the control of probe head 50.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

1. A system for testing an optical coupling device, the optical coupling device having one of an optical transmitter and an optical receiver, and an electrical contact portion wherein the electrical signal at said electrical contact portion is indicative of an optical signal either transmitted or received, the system comprising:
either or both of at least one optical receiver and at least one optical transmitter to optically interface with an optical coupling device;
a probe head comprising alignment means for physically interfacing with a predetermined optical coupling device to locate said optical interface at a predetermined position; and
electrical connection means operative to energize an optical coupling device or to receive an electrical output from an optical coupling device.

2. The system according to claim 1 further comprising optical conduit means interposed between said one or more of at least one optical receiver and at least one optical transmitter and said optical coupling device.

3. The system according to claim 1 wherein at least one of said either or both of at least one optical receiver and at least one optical transmitter are integral to said probe head.

4. The system according to claim 3 wherein one of said either or both of at least one optical receiver and at least one optical transmitter is positioned to directly optically interface with said optical coupling device when said alignment means is physically interfaced with said optical coupling device.

5. The system according to claim 1 wherein said electrical connection means is integral to said probe head.

6. The system according to claim 1 further comprising a motion control device operative to position said probe head.

7. The system according to claim 1 further comprising a movable stage for positioning said optical module for testing.

8. The system according to claim 1 further comprising electrical contact fingers for electrically interfacing said electrical connection means with an electrical contact portion of said optical module.

9. The system according to claim 1 wherein said either or both of at least one optical receiver and at least one optical transmitter are operative only in limited bands of the EM spectrum.

10. The system according to claim 1 wherein said alignment means comprises at least one alignment pin.

11. The system according to claim 1 wherein said alignment means comprises a machine vision system.

12. A method of testing an optical coupling device, the optical coupling device having one of an optical transmitter and an optical receiver, and an electrical contact portion wherein the electrical signal at said electrical contact portion is indicative of an optical signal either transmitted or received, the method comprising:
(a) using an alignment means of a probe head for physically interfacing with a predetermined optical coupling device to locate an optical interface between an optical transmitter or an optical receiver and said optical coupling device at a predetermined position;
(b) electrically interfacing said optical coupling device to energize said predetermined optical coupling device or to receive an electrical output from said predetermined optical coupling device;
(c) either applying electrical energy to the optical coupling device and collecting an optical output therefrom with said optical receiver, or applying optical energy to the optical coupling device with said optical transmitter and collecting an electrical output therefrom; and
(d) comparing the optical or electrical output from said optical coupling device to the optical or electrical output expected based on the electrical or optical energy applied.

13. The method according to claim 12 further comprising:
(e) using a motion control device to position said probe head for physically interfacing said optical coupling device.

14. The method according to claim 12 further comprising:
(e) using a movable stage to position said optical coupling device for physically interfacing said probe head.

15. The method according to claim 12 further comprising:
(e) providing an electrical connection means integral to said probe head for said electrically interfacing with said optical coupling device.

16. The method according to claim 12 wherein said optically energizing or said measuring an optical output is performed at a position relative to said optical coupling device determined by the dimensions of said alignment means.

17. The method according to claim 12 further comprising providing said alignment means with a machine vision system component, wherein said machine vision system component aids in aligning the physical interface of said probe head with a predetermined optical coupling device.
